(19) United States
(12) Patent Application Publication
(10) Pub. No.: US 2026/0094889 A1
(43) Pub. Date: Apr. 2, 2026

(54) SOLID-SOLID SEPARATION OF CARBON FROM A HARDLY SOLUBLE ALKALINE EARTH SULFATE

(71) Applicant: BASF SE, Ludwigshafen Am Rhein (DE)

(72) Inventors: Wolfgang ROHDE, Ludwigshafen am Rhein (DE); Dieter ETTMUELLER, Ludwigshafen am Rhein (DE); Petra JOHN, Ludwigshafen am Rhein (DE); Nils-Olof Joachim BORN, Ludwigshafen am Rhein (DE); Kai BACHMANN, Freiberg (DE); Anna VANDERBRUGGEN, Freiberg (DE)

(21) Appl. No.: 19/113,749

(22) PCT Filed: Oct. 12, 2023
(86) PCT No.: PCT/EP23/78280

§ 371 Date: Mar. 20, 2025

(30) Foreign Application Priority Data
Oct. 14, 2022 (EP) 22201631.3

(51) Int. Cl. H01M 10/54; B03C 1/30; B03D 1/02; C01B 32/205; C01F 11/46; C22B 26/12

(52) U.S. Cl. CPC H01M 10/54; B03C 1/30; B03D 1/023; C01B 32/205; C01F 11/46; C01F 11/462; C22B 26/12; B03C 2201/18

(57) ABSTRACT

Disclosed herein is a process for recycling carbon and a hardly soluble alkaline earth sulfate from a leaching residue, including the steps of contacting in an alkaline earth metal contacting step a lithium battery material with an alkaline earth metal including material in a solvent yielding an alkaline earth metal contacted lithium battery material: leaching in a leaching step the alkaline earth metal contacted lithium battery material in sulfuric acid yielding a leaching solution and the leaching residue; separating in a solid-liquid separation step the leaching residue from the leaching solution; suspending in a suspension step the leaching residue in a solvent yielding a suspended leaching residue: contacting in a carrier contacting step the suspended leaching residue with a plurality of at least one type of a carrier body; and separating in a solid-solid separation step at least a part of the carrier-body agglomerates from the suspension.

The project leading to this application has received funding from Bundesministerium für Wirtschaft und Klimaschutz (DE; FKZ: 16BZF 101A); the applicant bears responsibility for all disclosures herein.

### TECHNICAL FIELD

The present invention is concerned with a process for solid-solid separation of carbon from a hardly soluble alkaline earth sulfate, in particular for such a process in the recycling of lithium battery material.

### BACKGROUND

Storing electrical energy is a subject of growing interest. Efficient storage of electric energy would allow electric energy to be generated when it is advantageous and used when and where needed. Secondary electrochemical cells are well suited for this purpose due to their rechargeability. Hence, lithium batteries are of special interest for energy storage since they provide high energy density due to the small atomic weight and the large ionization energy of lithium, and they have become widely used as a power source for many portable electronics such as cellular phones, laptop computers, mini-cameras, etc. but also for electric vehicles.

Lifetime of batteries, especially lithium-ion batteries, is not unlimited. It is to be expected, therefore, that a growing number of spent batteries will emerge. Since they contain important metals such as, but not limited to cobalt, nickel, lithium, and, in addition, copper and aluminum, spent batteries may form a valuable source of raw materials for a new generation of batteries. For that reason, increased research work has been performed with the goal of recycling valuable metals—and, optionally, even aluminum—from used lithium-ion batteries.

Furthermore, recent developments on the world market have significantly increased the prices for important raw materials for battery production. Moreover, on Mar. 17, 2022, EU environment ministers unanimously adopted the council position on the EU batteries regulation. It is foreseeable that such a regulation will afford certain recycling rates for batteries as well as recycling yields for metals used in such. Furthermore, such regulation will most likely afford that at least a certain amount of the components used in the production of such a battery in the EU will afford that also the components were made in the EU. As there is no significant mining activity of the needed components in the EU, recycling will be the most favorable way to produce such components within the EU. Hence, the need for a sustainable, efficient and at best well integrated process for recycling of components of batteries, in particular lithium batteries, is needed.

The cathode as used in lithium batteries generally comprises a significant amount of aluminum as carrier foil for the cathode active material. Some cathode active material contain aluminum as well namely the nickel cobalt aluminum oxide materials (NCA). Common materials contain nickel, cobalt and manganese (NCM). Other cathode active materials are known, which contain no nickel or cobalt, but rather lithium manganese oxides or lithium iron phosphate.

Lithium-ion batteries or parts of lithium-ion batteries that do not meet the specifications and requirements, so-called off-spec materials and production waste, may as well be a source of raw materials.

Two main processes have been subject to raw material recovery. One main process is based upon smelting of the corresponding battery scrap followed by hydrometallurgical processing of the metallic alloy obtained from the smelting process.

The other main process is the direct hydrometallurgical processing of battery scrap materials. Principles have been disclosed in WO 2017/091562 and in J. Power Sources, 2014, 262, 255 ff.

Such hydrometallurgical processes will furnish transition metals as aqueous solutions or in precipitated form, for example as hydroxides, separately (DE-A-19842658), or already in the desired stoichiometries for making a new cathode active material, as proposed by Demidov et al., Ru. J. of Applied chemistry 78, 356 (2005). In the latter case the composition of metal salt solutions may be adjusted to the desired stoichiometries by addition of single metal components.

However, besides nickel, cobalt, manganese, and aluminum, the recovery of lithium from battery scrap has gained more and more interest. In WO 2021/018796 A1 a process is described for the recovery of one or more transition metals and lithium from waste lithium ion batteries. The process comprises the steps of treating the battery scrap material with an alkaline earth hydroxide, preferably calcium hydroxide, resulting in the formation of soluble lithium hydroxide, separating the solids from the liquid and treating the solids containing the transition metal using a mineral acid, preferably sulfuric acid, thereby producing as a side product a precipitate comprising significant amounts of carbon and a hardly soluble alkaline earth sulfate preferably gypsum.

Both components form valuable origins of resource. Elemental carbon can be again used in the production of batteries. On the other hand, hardly soluble alkaline earth sulfates are also of interest. For example, gypsum is produced in a significant amount i.e. by flue-gas desulfurization, to be used in the construction industry, agriculture and medicine. As flue-gas may become less available in the future due to turning to more sustainable technologies, also the need of new sources for gypsum might become urgent. On the other hand, barite is used as a pigment and in construction industry.

The problem of separating elemental carbon from a hardly soluble alkaline earth sulfate has not been addressed so far in the literature. There are many reports concerning the sequestering carbon as carbon dioxide employing gypsum (e. g. Kang, C.-U. et al., Sustainability 2022, 14, 4436) but this is not the field of the present invention.

### SUMMARY OF THE INVENTION

Hence, there is the need for a process, which allows for efficient separation of carbon and a hardly soluble alkaline earth sulfate from a solid mixture of both materials.

It is therefore an object of the present invention to provide an efficient process for the separation of a hardly soluble alkaline earth sulfate and carbon, in particular a process that can be easily and reliably integrated in a respective recycling process of lithium battery material.

It has now been surprisingly found that above-mentioned object can be achieved by a process comprising the steps of contacting in an alkaline earth metal contacting step a lithium battery material with a calcium alkaline earth metal comprising material in a solvent yielding an alkaline earth metal contacted lithium battery material, leaching in a leaching step the alkaline earth metal contacted lithium battery material in sulfuric acid yielding a leaching solution and the leaching residue, wherein the leaching residue comprises carbon and a hardly soluble alkaline earth sulfate, separating in a solid-liquid separation step the leaching residue from the leaching solution, suspending in a suspension step the leaching residue in a solvent yielding a suspended leaching residue, contacting in a carrier contacting step the suspended leaching residue with a plurality of at least one type of a carrier body, wherein at least a part of the carbon comprised in the suspended leaching residue is agglomerated with the plurality of at least one type of a carrier body yielding a suspension comprising carrier-body agglomerates comprising carbon and non-agglomerates comprising a hardly soluble alkaline earth sulfate or wherein at least a part of the hardly soluble alkaline earth sulfate comprised in the suspended leaching residue is agglomerated with the plurality of at least one type of a carrier body yielding a suspension comprising carrier-body agglomerates comprising a hardly soluble alkaline earth sulfate and non-agglomerates comprising carbon, separating in a solid-solid separation step at least a part of the carrier-body agglomerates from the suspension.

Hence, both carrier-agglomeration and subsequent separation processes are conceivable. However, in the majority of practical cases the hydrophobic material will be agglomerated with hydrophobic carrier bodies. However, so called inverse flotation processes where the hydrophilic components are separated in the concentrate are known in the art. Such processes are usually realized by an inversion of the surface tension properties of the target particles. In the following the focus will be laid on the cases where hydrophobic agglomerates are formed. However, this is by no means a general limitation so processes where the hydrophilic hardly soluble alkaline earth sulfate component is agglomerated are included in this invention. Therefore, preferably, in the process of the present invention, the carrier contacting step is a step in which the suspended leaching residue is contacted with a plurality of at least one type of a carrier body, wherein at least a part of the carbon comprised in the suspended leaching residue is agglomerated with the plurality of at least one type of a carrier body yielding a suspension comprising carrier-body agglomerates comprising carbon and non-agglomerates comprising the hardly soluble alkaline earth sulfate.

One advantageous effect of the invention is that the process works on a solid-solid separation basis. Hence, no dissolution steps are needed involving the need of high energy input. Furthermore, the process can be used directly with the product emerging from the sulfuric acid leaching step. Hence, tight and efficient integration into a lithium battery material recycling process is provided.

### BRIEF DESCRIPTION OF THE DRAWINGS

FIG. 1 shows a XRD spectrum of the black mass employed in Example 1 (black graph).

### DEFINITIONS

Before describing in detail exemplary embodiments of the present invention, definitions which are important for understanding the present invention are given.

The term “black mass” as used herein denotes the solid residue obtained by dismantling and comminuting of batteries. The black mass is obtained as fine fraction of classifying stages and comprises the active materials of the cathodes and anodes of the batteries together with some impurity particles. This black mass can either be directly treated in a hydrometallurgical process or after a pyrolysis treatment.

As used in this specification and in the appended claims, the singular forms of “a” and “an” also include the respective plurals unless the context clearly dictates otherwise. In the context of the present invention, the terms “about” and “approximately” denote an interval of accuracy that a person skilled in the art will understand to still ensure the technical effect of the feature in question. The term typically indicates a deviation from the indicated numerical value of +10%, preferably +8%, more preferably +5%, even more preferably +2%. It is to be understood that the term “comprising” and “encompassing” is not limiting. For the purposes of the present invention the term “consisting of” is considered to be a preferred embodiment of the term “comprising of”. If hereinafter a group is defined to comprise at least a certain number of embodiments, this is meant to also encompass a group which preferably consists of these embodiments only. Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(a)”, “(b)”, “(c)”, “(d)”, “i”, “ii” etc. relate to steps of a method or use or assay there is no time or time interval coherence between the steps, i.e. the steps may be carried out simultaneously or there may be time intervals of seconds, minutes, hours, days, weeks, months or even years between such steps, unless otherwise indicated in the application as set forth herein above or below. It is to be understood that this invention is not limited to the particular methodology, protocols, reagents etc. described herein as these may vary. It is also to be understood that the terminology used herein is for the purpose of describing particular embodiments only, and is not intended to limit the scope of the present invention that will be limited only by the appended claims. Unless defined otherwise, all technical and scientific terms used herein have the same meanings as commonly understood by one of ordinary skill in the art.

As used herein the term “does not comprise”, “does not contain”, or “free of” means in the context that the composition of the present invention is free of a specific compound or group of compounds, which may be combined under a collective term, that the composition does not comprise said compound or group of compounds in an amount of more than 0.8% by weight, based on the total weight of the composition. Furthermore, it is preferred that the composition according to the present invention does not comprise said compounds or group of compounds in an amount of more than 0.5% by weight, preferably the composition does not comprise said compounds or group of compounds at all.

When referring to compositions and the weight percent of the therein comprised ingredients it is to be understood that according to the present invention the overall amount of ingredients does not exceed 100% (+1% due to rounding).

### DETAILED DESCRIPTION OF THE PRESENT INVENTION

The process of the present invention is a process for recycling carbon and a hardly soluble alkaline earth sulfate from a leaching residue, comprising the steps of:

contacting in an alkaline earth metal contacting step a lithium battery material with an alkaline earth metal comprising material in a solvent yielding an alkaline earth metal contacted lithium battery material;

leaching in a leaching step the alkaline earth metal contacted lithium battery material in sulfuric acid yielding a leaching solution and the leaching residue, wherein the leaching residue comprises carbon and the hardly soluble alkaline earth sulfate;
separating in a solid-liquid separation step the leaching residue from the leaching solution; suspending in a suspension step the leaching residue in a solvent yielding a suspended leaching residue;

contacting in a carrier contacting step the suspended leaching residue with a plurality of at least one type of a carrier body, wherein at least a part of the carbon comprised in the suspended leaching residue is agglomerated with the plurality of at least one type of a carrier body yielding a suspension comprising carrier-body agglomerates comprising carbon and the hardly soluble alkaline earth sulfate non-agglomerates comprising the hardly soluble alkaline earth sulfate or wherein at least a part of the hardly soluble alkaline earth sulfate comprised in the suspended leaching residue is agglomerated with the plurality of at least one type of a carrier body yielding a suspension comprising carrier-body agglomerates comprising the hardly soluble alkaline earth sulfate and non-agglomerates comprising carbon;

separating in a solid-solid separation step at least a part of the carrier-body agglomerates from the suspension.

Usually, in the recycling processes for batteries, in particular lithium-ion based batteries, a pyrolysis step is involved. Such a pyrolysis step usually is a thermal pre-treatment step, in which the pre-sorted batteries or battery components are heated so that their constituent organics are decomposed. Hence, preferably, the lithium battery material of the contacting step of the process of the present invention is a pyrolyzed lithium battery material. Preferably the pyrolysis step is performed under inert or reducing conditions. In the latter case reducing gases preferably are selected from hydrogen, carbon monoxide, nitrogen or hydrocarbons like methane (from natural gas). In the case of inert conditions, the presence of air or oxygen is excluded and the atmosphere consists mainly of inert gases like nitrogen, but also carbon dioxide could be present. When employing a directly heated oven hydrocarbon/oxygen or -air mixtures are incinerated leaving an atmosphere comprising mainly nitrogen and carbon dioxide.

The leaching residue used in the process of the present invention comprises carbon. Said carbon mainly originates from carbon being present in the leached lithium battery material. Lithium battery material itself already contains carbon as anode material. As the lithium battery material is preferably a pyrolyzed lithium battery material, also other carbon-based compounds may have been formed at least partially to carbon during the pyrolysis process. This carbon generally can be present in any modification known for carbon except diamond. Hence, preferably, in the process of the present invention, the carbon is amorphous carbon, preferably selected from the list consisting of carbon black and pyrolysis coke, or crystalline carbon, preferably selected from the list consisting of graphite, graphene, fullerenes, buckyballs, nanotubes, and mixtures thereof. More preferably, the carbon in the process of the present invention is crystalline carbon, preferably selected from the list consisting of graphite, graphene, fullerenes, buckyballs, nanotubes, and mixtures thereof, most preferably is graphite.

The alkaline earth metal contacting step primarily provides a suspension of the lithium battery material in a polar solvent. Preferably, the polar solvent is a protic solvent, more preferably water.

The term “protic solvents” as used herein, denotes water, alcohols, and mixtures thereof. An aqueous medium such as an aqueous solvent or aqueous liquid contains primarily (i.e., by 50 wt % or more, preferably 80 wt % or more, more preferably 90 wt % or more) water, it includes water and mixtures of water with one or more alcohols. It may contain further dissolved substances as long as the major water content is maintained within one or more of the ranges given above.

The term “alkaline earth metals” as denoted herein preferably refers to alkaline earth metals, which form hardly soluble sulfate, preferably calcium, strontium, and barium, more preferably calcium and barium, most preferably calcium.

The term “hardly soluble alkaline earth sulfates” as used herein denotes alkaline earth sulfates, which are hardly soluble in water, preferably calcium sulfate, strontium sulfate, and barium sulfate, more preferably calcium sulfate and barium sulfate, most preferably calcium sulfate.

The term “calcium sulfate” as used herein denotes the pure compound calcium sulfate, but also naturally occurring compounds such as gypsum, which mainly consist of calcium sulfate having minor impurities and optionally water content.

The term “barium sulfate” as used herein denotes the pure compound barium sulfate, but also naturally occurring compounds such as barite, which mainly consist of barium sulfate having minor impurities and optionally water content.

Preferably, the alkaline earth metal contacting step is carried out with heating. Preferably, it is carried out at temperatures in the range from 60 to 200° C., preferably 70 to 150° C. Where the boiling point of the polar solvent is exceeded, the alkaline earth metal contacting step is carried out under pressure to hold the solvent, or at least a fraction thereof, in the liquid state. Of special technical importance is the temperature range around the boiling point of water, i.e., about 70 to 150° C., where the treatment can be achieved using an aqueous liquid or water at normal pressure or slightly elevated pressure (e.g. up to 5 bar). Alternatively, the alkaline earth metal contacting step can be carried out with at higher temperatures and pressures, e.g., 150 to 300° C. and 1.5 to 100 bar. Most preferably, the alkaline earth metal contacting step is carried out at normal pressure at a temperature in the range of from 95 to 100° C.

The alkaline earth metal contacting step is carried out by combining an amount of alkaline earth metal comprising material (ACM), preferably selected from the list consisting of calcium oxide, calcium hydroxide, calcium hypochlorite, strontium hydroxide or oxide and barium hydroxide or oxide or mixtures thereof, with the lithium battery material (LBM), whereas ACM preferably corresponds to at least 5 wt %, and not more than 250 wt % of the weight of LBM, e.g., 50-2500 g of ACM on 1 kg of LBM, more preferably 100-1000 g ACM on 1 kg of LBM, and most preferably 200-1000 g on 1 kg of LBM. It should be understood that in certain embodiments of the invention the ACM may be added prior to the pyrolysis to the LBM. In such an embodiment, in the alkaline earth metal contacting step the solvent can be added solely to achieve the contacting. It may also be that this embodiment is mixed with the embodiment in which the ACM is added with the solvent. Hence, it may be that the ACM is added to the LBM already prior to pyrolysis, but in the contacting step not only solvent, but also additional ACM is added.

Preferably, in the alkaline earth metal comprised in the alkaline earth metal comprising material used in the alkaline earth metal contacting step is calcium or barium, most preferably calcium. If the alkaline earth metal comprised in the alkaline earth metal comprising material is barium, the alkaline earth metal comprising material is preferably barium hydroxide or oxide. If the alkaline earth metal comprised in the alkaline earth metal comprising material is calcium, the alkaline earth metal comprising material is preferably selected from calcium hydroxide, calcium oxide, or calcium hypochlorite, preferably is calcium hydroxide.

The amount of polar solvent in the alkaline earth metal contacting step is typically chosen to ensure miscibility of the components, e.g. using on one part by weight of combined solids (LBM and ACM) 0.5 to 95, preferably about 2.5 to 21 parts by weight of the polar solvent; or in certain cases 1 to 20, e.g. about 2 to 10 parts by weight of the polar solvent.

Preferably, in the alkaline earth metal contacting step of the process of the present invention, the molar ratio between the alkaline earth metal comprised in the alkaline earth metal comprising material and the lithium comprised in the lithium battery material is in the range of 10:1 to 1:10.

In one preferred embodiment of the present invention, the alkaline earth metal contacting step is carried out in a vessel that is protected against strong bases, for example molybdenum and copper rich steel alloys, nickel-based alloys, duplex stainless steel or glass-lined or enamel or titanium coated steel. Further examples are polymer liners and polymer vessels from base-resistant polymers, for example polyethylene such as HDPE and UHMPE, fluorinated polyethylene, perfluoroalkoxy alkanes (“PFA”), polytetrafluoroethylene (“PTFE”), PVdF and FEP. FEP stands for fluorinated ethylene propylene polymer, a copolymer from tetrafluoroethylene and hexafluoropropylene.

The alkaline earth metal contacting step is preferably carried out using a mixing device, e.g., a stirrer, with power application preferably up to 10 W per kg of suspension, more preferably 0.5 to 10 W/kg, and/or cycled by pumping to achieve a good mixing and to avoid settling of insoluble components. Shearing can be preferably further improved by employing baffles. Furthermore, the slurry obtained in the alkaline earth metal contacting step may preferably be subjected to a grinding treatment, for example in a ball mill or stirred ball mill. Such grinding treatment may lead to a better access of the polar solvent to the lithium battery material. Shearing and milling devices applied are preferably sufficiently corrosion resistant. Preferably, they are produced from similar materials and coatings as described above for the vessel.

Preferably, the alkaline earth metal contacting step has a duration in the range of from 20 min to 24 h, more preferably 2 h to 10 hours, even more preferably of 4 h to 8 h, and most preferably of 5 h to 7 h.

In a particularly preferred embodiment of the present invention, the alkaline earth metal contacting step is carried out at least twice to reach an optimum recovery of lithium salt. Between each treatment preferably a solid-liquid separation is performed. The obtained lithium salt solutions may be combined or treated separately to recover the solid lithium salt. The specific lithium salt formed during the alkaline earth metal contacting step depends on the alkaline earth metal comprising material used. Calcium oxide, calcium hydroxide, and barium hydroxide and oxide result in the formation of lithium hydroxide, whereas calcium hypochlorite results in the formation of lithium chloride.

The alkaline earth metal contacted lithium battery material obtained in the alkaline earth metal contacting step is preferably recovered by solid-liquid separation. This can be a filtration, a centrifugation, a kind of sedimentation, a decantation, or combinations thereof, preferably with subsequent washing steps applying the respective polar solvent used in the alkaline earth metal contacting step as washing medium. The filtrate and washing liquids are preferably combined prior to further work up targeting the lithium salt. To recover such solid material containing fine particles, for example with an average diameter of 50 μm or less, flocculants may be added, for example polyacrylates.

The alkaline earth metal contacted lithium battery material obtained is preferably characterized by an elemental weight content of alkaline earth metal between 2 and 70 wt % with respect to the total dry mass of the alkaline earth metal contacted lithium battery material.

The alkaline earth metal contacted lithium battery material obtained in the alkaline earth metal contacting step is subsequently subjected to a leaching step. Preferably, however, before the leaching step a subsequent solid-solid separation step for the removal of Ni and/or Co if present can be carried out. By performing such a step, nickel can be recovered as a nickel containing solid.

Likewise, preferably, the alkaline earth metal contacting step and the subsequent solid-solid separation step are performed in batch mode. In another preferred embodiment of the present invention, the alkaline earth metal contacting step and the subsequent solid-solid separation step are performed in continuous mode, e.g., in a cascade of stirred vessels (alkaline earth metal contacting step) and/or in a cascade of stirred vessel plus centrifuge (subsequent solid solid separation step).

In the leaching step, sulfuric acid, preferably aqueous sulfuric acid, leaching is applied. The concentration of the aqueous sulfuric acid is preferably in the range of from 10 to 98 wt %, most preferably 10 to 80 wt %. Hence, the sulfuric acid in the leaching step is preferably present in a concentration of at least 0.05 wt %, more preferably at least 0.5 wt %, and most preferably at least 5 wt %. Preferably, the aqueous sulfuric acid has a pH value in the range of from −1 to 2. The amount of acid is preferably adjusted to maintain an excess of acid referring to the transition metals still present in the alkaline earth metal contacted lithium battery material. Preferably, at the end of the leaching step the pH value of the resulting solution is in the range of from −0.5 to 2.5.

The leaching step may be carried out in the presence of oxidizing agents. Preferably, the oxidizing agent is selected from the list consisting of oxygen, air, hydrogen peroxide, dinitrogen oxide, metal oxide compounds like lithium metal oxides, permanganates, ferrates, or mixtures thereof. A preferred oxidizing agent is oxygen as pure gas or in mixtures with inert gases e.g. nitrogen or as air.

The leaching step is preferably carried out at a temperature in the range of from 20 to 200° C., more preferably 20 to 130° C., even more preferably 50 to 110° C., still even more preferably 70 to 105° C., and most preferably 85 to 100° C. If temperatures above 100° C. are desired, the leaching step is carried out at a pressure above 1 bar. Otherwise, normal pressure is preferred.

In one preferred embodiment of the present invention, the leaching step is carried out in a vessel that is protected against strong acids, for example molybdenum and copper rich steel alloys, nickel-based alloys, duplex stain less steel or glass-lined or enamel or titanium coated steel. Further examples are polymer liners and polymer vessels from acid-resistant polymers, for example polyethylene such as HDPE and UHMPE, fluorinated polyethylene, perfluoroalkoxy alkanes (“PFA”), polytetrafluoroethylene (“PTFE”), PVDF and FEP.

The slurry obtained in the leaching step may be stirred, agitated, or subjected to a grinding treatment, for example in a ball mill or stirred ball mill. Such grinding treatment leads often to a better access of water or acid to a particulate transition metal material.

In one preferred embodiment of the present invention, the leaching step has a duration in the range of from 10 min to 10 h, preferably 1 h to 9 h, more preferably of 3 h to 7 h, and most preferably of 4 h to 6 h. For example, the reaction mixture in the leaching step is stirred at powers of at least 0.1 W/l or cycled by pumping to achieve a good mixing and to avoid settling of insoluble components. Shearing can be further improved by employing baffles. All these shearing devices need to be applied sufficiently corrosion resistant and may be produced from similar materials and coatings as described for the vessel itself.

The leaching step may be performed under an atmosphere of air or under air diluted with N2. It is preferred to carry the leaching step out under inert atmosphere, for example nitrogen or a noble gas such as Ar.

The treatment in accordance with leaching step leads to a dissolution of the metal compounds that remain after the alkaline earth metal contacting step, including impurities other than carbon and organic polymers. In most embodiments, a slurry is obtained after carrying out the leaching step. Residual lithium and transition metals such as, but not limited to nickel, cobalt, copper and, if applicable, manganese, are often in dissolved form in the leach, e.g., in the form of their salts.

In embodiments wherein a so-called oxidizing acid or oxidants have been used in the leaching step, it is preferred to add reducing agent to remove non-used oxidant. Examples of oxidizing acids are nitric acid and combinations of nitric acid with hydrochloric acid, examples of oxidants are lithium-metal oxides, hydrogen peroxide or oxygen.

After the leaching step the solid-liquid separation step is preferably carried out as a separation step according to one or more of the list consisting of a filtration step, a centrifugation step, a sedimentation step, and a decantation step, preferably is carried out as a filtration step. The solid residue obtained may be washed with polar solvent.

Preferably, the leaching step and the solid-liquid separation step are carried out sequentially in a continuous operation mode.

As the leaching step preferably employs polar solvents, preferably protic solvents, more preferably water, also the solvent used in the suspension step of the process according to the present invention is a preferably a polar solvent, more preferably protic solvent, most preferably water.

In one preferred embodiment of the present invention, the suspension step is carried out in a vessel that is protected against strong acids, for example molybdenum and copper rich steel alloys, nickel-based alloys, duplex stain less steel or glass-lined or enamel or titanium coated steel. Further examples are polymer liners and polymer vessels from acid-resistant polymers, for example polyethylene such as HDPE and UHMPE, fluorinated polyethylene, perfluoroalkoxy alkanes (“PFA”), polytetrafluoroethylene (“PTFE”), PVDF and FEP.

The suspension obtained in the suspension step may be stirred, agitated, or subjected to a grinding treatment, for example in a ball mill or stirred ball mill. Such grinding treatment leads often to a finer suspension. The carbon particles in the suspension have in general an average diameter that enables this particle to efficiently agglomerate with the carrier bodies in the subsequent carrier contacting step. In a preferred embodiment, the carbon particles have a D50 of from 1 nm to 1 mm, and preferably of from 0.1 μm to 500 μm and most preferred in the range between 1 μm and 250 μm. The particle size of the carbon particles can be reduced by grinding or milling.

In the subsequent carrier contacting step of the process of the present invention, the suspended leaching residue is contacted with a plurality of at least one type of a carrier body, wherein preferably at least a part of the carbon comprised in the suspended leaching residue is agglomerated with the plurality of at least one type of a carrier body yielding preferably a suspension comprising carbon-carrier-body agglomerates and the hardly soluble alkaline earth sulfate.

The term “carrier body” as used herein denotes a compound or physical entity, which can bind to one or more of the particles to be separated, preferably carbon particles, in the suspension either by physical interactions or chemical interactions. Thereby those interactions can reach from covalent bonding via dipole-dipole bonds up to Van-der-Waals interactions. Physical interactions can be specific encapsulation of the particles to be separated, preferably carbon particles, in cavities, whereby these cavities may be formed by chemical structures or physical means such as phase boundaries. It preferred that the carrier bodies specifically interact with the particles to be separated, preferably carbon particles, and not with the particles not to be separated, preferably the hardly soluble alkaline earth sulfate particles. Carbon is usually a non-polar compound, while the hardly soluble alkaline earth sulfate as a salt interacts preferably with polar compounds and entities. Hence, the properties of the carrier body have to be chosen accordingly. Thus, preferably, a further requirement for the carrier bodies is that they form agglomerates either with each other or with the bound carbon residue, preferably with each other. Such agglomeration ensures easier separation of the carbon-carrier-bodies. Finally, the interactions of the carbon-carrier-bodies must be separable after solid-solid separation of the carbon-carrier-bodies from the hardly soluble alkaline earth sulfate.

In the carrier contacting step, preferably, a collector is added to the suspension. A suitable collector selectively forms a hydrophobic layer on the carbon particles. Suitable collectors are preferably liquid, non-polar compounds that do not dissociate in water. Preferably, the collector is a hydrocarbon. The hydrocarbon may be a uniform hydrocarbon or a hydrocarbon mixture. The hydrocarbons may have a viscosity of from 0.1 to 100 cP, preferably from 0.5 to 5 cP, in each case at 20° C. The hydrocarbon may be mineral oils, vegetable oils, biodiesel, BtL (Biomass-to-Liquid) fuels, products of coal liquefaction, products of the GtL (Gas to Liquid, from natural gas) process, long chain alcohols, and mixtures thereof. The collector is preferably a mineral oil. Suitable mineral oils are crude oil derivatives and/or oils produced from brown coal, hard coal, peat, wood, petroleum and, if appropriate, other mineral raw materials by distillation. Mineral oils generally comprise hydrocarbon mixtures of paraffinic hydrocarbons, i.e. saturated linear and branched hydrocarbons, naphthenic hydrocarbons, i.e. saturated cyclic hydrocarbons, and aromatic hydrocarbons. Preferably, the collector is selected from non-polar hydrocarbons, preferably non-polar aliphatic hydrocarbons, and most preferably C₉ to C₁₇ aliphatic non-polar hydrocarbons.

The collector is added to the suspension typically in an amount up to 15 wt % with respect to the total dry mass of the suspension, preferably up to 7 wt %, and in particular up to 4 wt %. More specifically, the suspension comprises typically 0.001 to 10 wt %, preferably 0.1 to 5 wt %, and in particular 0.2 to 3 wt % of the collector with respect to the total dry mass of the suspension. In another preferred embodiment form the suspension comprises typically at least 0.05 wt %, preferably at least 0.1 wt %, and in particular at least 0.3 wt % of the collector with respect to the total dry mass of the suspension.

Hence, after the carrier contacting step, a solid-solid separation step is carried out, in which the carrier-body agglomerates are separated from the hardly soluble alkaline earth sulfate suspension. Hence, the carrier contacting step and the solid-solid separation step are connected to each other in that the carrier-body agglomerates must be suitable for being separated by the solid-solid separation step.

Preferably, the solvent in the carrier contacting step is a polar solvent, more preferably a protic solvent, most preferably water.

Usually, after the leaching step, the leaching residue has a low pH value. Hence, preferably, in the carrier contacting step prior to the addition of the plurality of at least one type of carrier body the pH value of the solvent is adjusted to a pH value of higher than 3, preferably in the range of 3 to 8. Preferably, the pH value is adjusted in the carrier contacting step prior to the addition of the plurality of at least one type of carrier bodies by addition of a base selected from the list consisting of alkali hydroxides, alkali carbonates, ammonium hydroxide, alkali earth hydroxides, alkali earth carbonates or mixtures thereof, preferably is at least one alkali hydroxide, preferably is sodium hydroxide.

Preferably, the type of carrier body is selected from gas bubbles of a carrier gas and magnetic particles.

Suitable magnetic particles may be selected from magnetic metals, preferably iron and its alloys, cobalt, nickel and mixtures thereof, ferromagnetic or ferrimagnetic alloys of magnetic metals, for example NdFeB, SmCo and mixtures thereof, magnetic iron oxides, for example magnetite, magnetic hematite, hexagonal ferrites, cubic ferrites, and mixtures thereof. Preferably, the magnetic particle is a magnetic iron oxide, in particular magnetite.

The magnetic particles have in general an average diameter that enables this particle to efficiently agglomerate with the desired particles. In a preferred embodiment, the magnetic particle has a D50 of from 1 nm to 1 mm, and preferably of from 0.1 μm to 50 μm and most preferred in the range between 1 μm and 20 μm.

The wording “D50” means that 50% by weight of the corresponding particles have a diameter that is smaller than the mentioned value. The particle size of the magnetic particles, such as the magnetite, can be reduced prior use by grinding or milling.

In general, the amount of the magnetic particles to be applied in the method of the present invention can be determined in a way that advantageously the whole amount of the particles to be separated, preferably carbon particles, can be separated by agglomerating with the magnetic particles. In a preferred embodiment, the magnetic particles are added in an amount of from 0.01 to 100% by weight, preferably from 0.1 to 20% by weight, particularly preferably from 0.5 to 10% by weight and most preferably 1 to 5% by weight, with respect to the total dry mass of the dry leaching residue.

The magnetic particle is a hydrophobic magnetic particle. Usually, the magnetic particle is hydrophobized on its surface, i.e., is a hydrophobized magnetic particle. Preferably, the magnetic particle has been hydrophobized by treatment with a hydrophobizing agent, wherein preferably the magnetic particle treated with the hydrophobizing agent has a contact angle between the particle surface and water against air of preferably more than 30°, more preferably more than 60°, even more preferably more than 90° and particularly preferably more than 140°. Preferably, the magnetic particle has been pre-treated with the hydrophobizing agent before the carrier contacting step.

In general, the hydrophobizing agent may be any agent that will render the surface of the magnetic particle more hydrophobic than the surface of the magnetic particle before the treatment. Suitable hydrophobizing agents and methods to prepare hydrophobic magnetic particles by treatment with the hydrophobizing agents are known, such as those listed in WO 2016/083491, p. 19, I. 21 to p. 27, I. 30, or in WO 2015/110555 p. 7, I. 9 to p. 11, I. 32.

Examples of hydrophobizing agents are
polyorganosiloxanes;
alkylsiliconates, e.g., alkali or earth alkali C₁₋₆ alkylsiliconates, in particular methylsiliconate;
alkyltrichlorosilanes, e.g., C₆₋₁₂ alkyltrichlorosilanes;
alkyltrimethoxysilanes, e.g., C₆₋₁₂ alkyltrimethoxysilanes;
alkylphosphonic acids, e.g., C₆₋₁₈ alkylphosphonic acids, in particular octylphosphonic acid;
mono- or dialkylphosphoric esters, e.g., C₆₋₁₈ mono- or dialkylphosphoric;
fatty acids, e.g., C₆₋₁₈ fatty acid, in particular lauric acid, oleic acid, stearic acid; maleic acid olefin copolymers or mixtures thereof.

The hydrophobizing agent is preferably a polyorganosiloxane. Polyorganosiloxanes (also known as silicones) have usually the formula [RₘSi(O)_{4-m/2}]ₙ where m is from 1 to 3, n is at least 2, and R an organic rest, such as methyl, ethyl, or phenyl. The polyorganosiloxanes may be linear, cyclic or branched. Suitable polyorganosiloxanes and their preparation are known form Ullmann's Encyclopedia of Industrial Chemistry, Volume 32, Entry “Silicones”, Wiley-VCH, 2012, page 675-712.

Suitable polyorganosiloxanes are silicon oil, silicon rubber, silicon resin, or block and graft polyorganosiloxane copolymers, wherein silicon oil and silicon resin are more preferred.

Silicon oil (also known as silicon fluids) are usually linear polyorganosiloxanes with typically 2 to 4000 monomer units. Suitable silicon oils are methylsilicone oil, methylphenylsilicon oil, fluorsilicone oil, methylhydrogensilicon oil, or methylalkylsilicone oil. Preferred silicon oils are methylsilicone oil and methylphenylsilicon oil.

Suitable methylsilicone oil are linear polydimethylsiloxanes, which may have a molecuar mass from 500 to 200,000 g/mol. Suitable methylphenylsilicone oil are linear polydimethylsiloxanes, where the methyl groups are partly substituted by phenyl groups, and which may have a molecular mass from 500 to 200,000 g/mol.

Silicone resins are typically branched polyorganosiloxanes with a molecular weight of below 15,000 g/mol, preferably below 10,000 g/mol. Silicone resins are usually soluble in organic solvents, such as toluene. Preferred silicone resins are MQ, TD and T type silicone resins.

Typically, silicone resins are prepared by hydrolysis or alcoholysis of organochlorosilanes, such as methyltrichlorosilane, phenyltrichlorosilane, dimethyldichlorosilane, and diphenyldichlorosilane.

Preferably, the hydrophobizing agent is a silicone resin, such as a branched polyorganosiloxanes with the formula [RₘSi(O)_{4-m/2}], where m is from 1.1 to 3, n is at least 10, and R an organic rest, such as methyl or phenyl with a molecular mass below 10,000 g/mol.

Suitable block and graft polyorganosiloxane copolymers are polyorganosiloxane-polyether block polymers, where the polyether block may contain polyethylene glycol and/or polypropylene glycol; or graft polymers of polyorganosiloxane with vinyl monomers, such as styrene, acrylate, or vinyl acetate).

Preferably, the magnetic particles comprise hydrophobized magnetite, preferably magnetite hydrophobized using a polyorganosiloxane as explained above.

Both the gas bubbles and the magnetic particles form agglomerates specifically with carbon. This is due to the hydrophobic character of both entities. The gas bubble has a polar solvent-gas phase boundary and a non-polar gas phase inside. Hence, the carbon particles tend to agglomerate at the surface of or in the phase boundary making use of preferred non-polar interactions. On the other hand, the hydrophobized magnetic particles agglomerate with the hydrophobic carbon particles thereby forming hydrophobic agglomerates aiming to minimize their surface towards the polar solvent.

Preferably, the carrier gas is a gas being inert to the suspension, preferably is selected from the list consisting of air, oxygen reduced air, nitrogen and carbon dioxide.

Generally, the solid-solid separation step can be carried out by a process step selected from sorting, electric separation, magnetic separation, screening, classification, gravity concentration, flotation, or mixtures thereof.

If the type of carrier body is a gas bubble, the solid-solid separation step preferably is a flotation step.

The term “flotation” as used therein denotes a process step, in which the injection of the carrier gas in a flotation cell leads to formation of hydrophobic gas bubbles, which can transport hydrophobic or hydrophobized particles to the top of the flotation cell. The formed froth, which can be further stabilized by a suitable chemical acting as a frother, contains the concentrated hydrophobic or hydrophobized particles (usually denoted concentrate). Finally, the froth is removed from the top and the non-hydrophobic particles are left at the bottom of the flotation cell, usually denoted as tailings. Preferably, the flotation step is carried out in a mechanical flotation cell, in a pneumatic flotation cell, in a column flotation cell or in a process comprising a plurality of flotation cells that may be of the same or different types.

Usually, the frother is a surfactant, preferably an organic heteropolar compound, more preferably an alcohol or polyglycol ether, and most preferably methyl isobutyl carbinol (MIBC).

It should be understood that the solid-solid separation step can be carried out in several steps. Thereby, the same kind of solid-solid separation step can be repeated more than once or different kinds of separation steps can be combined. For example, in case of flotation it is preferred that the solid-solid separation step comprises more than one flotation step, preferably comprises a rougher step, a scavenger step, a cleaner step, or combinations thereof. Thereby, the rougher step can be considered as a first flotation step. The scavenger step is a second flotation step using the tailings of said first flotation step (rougher step). Hence, the scavenger step is usually carried out to enhance the separation yield of the carbon particles. Consequently, the froths of the rougher step and the scavenger step are preferably combined. The cleaner step is preferably carried out using the froth of the rougher step or the combined froths of the rougher step and the scavenger step. This froth is again suspended in fresh polar solvent and subjected to a flotation step. The cleaner step is preferably carried out to enhance the purity of the carbon particles.

After the flotation step or the combination of flotation steps both the tailings and the froth(s) are preferably subjected to a solid-liquid separation step, the separated solids preferably washed with a suitable solvent, preferably a polar solvent, and dried for further use.

Hence, in one preferred embodiment of the carrier body contacting step and the solid-solid separation step of the present invention, the carrier bodies are gas bubbles from a carrier gas, wherein the carrier gas preferably is an inert gas, most preferably air, and the solid-solid separation step comprises at least one flotation step, preferably a rougher step, a scavenger step, a cleaner step, or combinations thereof, most preferably a rougher step, a scavenger step and a cleaner step.

If the type of carrier body is a magnetic particle, the solid-solid separation step preferably is selected from flotation, magnetic separation, or combinations thereof, preferably is magnetic separation. Magnetic separation is usually achieved by separation using a magnetic field. The separation by a magnetic field may be conducted by any method known to the person skilled in the art. Suitable magnetic separators are drum separators, high or low intensity magnetic separators, continuous belt type separators or others. Permanent magnets or electromagnets can be used to generate the magnetic field. The magnetic separation may be performed by a continuous or semi-continuous magnetic separation technology as described by e.g. Jan Svoboda “Magnetic Techniques for the Treatment of Materials” (2004).

Suitable magnetic separators are of the LIMS (low intensity magnetic separator), MIMS (medium intensity magnetic separator) or WHIMS (wet high intensity magnetic separator) type as known in the art. In a preferred embodiment of this invention the separators are of the MIMS or WHIMS type. Typical apparatus used for the magnetic separation are disclosed in WO 2011/131411, WO 2011/134710, WO 2011/154178, DE 10 2010 023 130, DE 20 2011 104 707, WO 2011/107353, DE 10 2010 061 952, WO 2012/116909, WO 2012/107274, WO 2012/104292 or WO 2013/167634. The magnetic separator preferably further comprises at least one magnet that is movable alongside a canal through which the slurry containing the magnetisable particles flows. The magnetic separator is preferably operated in countercurrent i.e., the movement of the magnetic field is opposite to the direction of the suspension flow. The field strength of the magnetic field may be at least 0.1, preferably at least 0.3 and in particular at least 0.5 Tesla.

In a preferred embodiment, the magnetic separation equipment allows washing the agglomerate during separation with a dispersant, preferably water. The washing preferably allows removing inert material i.e., material that is not hydrophobized from the agglomerate.

This magnetic separation step can be repeated, in particular by repeated flow of the non-magnetic product of the foregoing separation step through a consecutive separation path or by modulating the magnetic field. In this consecutive separation steps (known in the art as scavenging) further amounts of collector and/or the hydrophobic magnetic particles may be added prior to the magnetic separation stage as described above for the step b). The agglomerates can be stirred after a first separation and before a second separation, so that trapped second type particles can be set free and can be separated in the second separating step (known in the art as cleaning).

After the step of magnetic separation, the carbon-carrier-body agglomerates need to be broken up to obtain a suspension comprising the magnetic particles in desagglomerated form.

The breakup of the isolated agglomerates and the separation of the carbon particles from the magnetic particles are usually done in order to recycle the magnetic particles. The breakup can be achieved by adding a cleaving agent. The cleaving agent may comprise organic solvents, basic compounds, acidic compounds, oxidants, reducing agents, surfactants or mixtures thereof. Preferably, the cleaving agent comprises a mixture of water and surfactant, most preferably the cleaving agent is a surfactant.

Examples of organic solvents as cleaving agents are alcohols, such as methanol, ethanol, propanol, for example n-propanol or isopropanol; aromatic solvents, for example benzene, toluene, xylenes; ethers, for example diethyl ether, methyl t-butyl ether; ketones, for example acetone; aromatic or aliphatic hydrocarbons, for example saturated hydrocarbons with for example 6 to 10 carbon atoms, for example dodecane, Diesel fuel and mixtures thereof. The main components of Diesel fuel are predominantly alkanes, cycloalkanes and aromatic hydrocarbons having about 9 to 22 carbon atoms per molecule and a boiling range between 170° C. and 390° C.

The acidic compounds can be mineral acids, for example HCl, H₂SO₄, HNO₃ or mixtures thereof, organic acids, for example carboxylic acids.

As oxidants, it is possible to use H₂O₂, for example as 30% strength by weight aqueous solution.

Examples of basic compounds are aqueous solutions of basic compounds, for example aqueous solutions of alkali metal and/or alkaline earth metal hydroxides, such as KOH or NaOH; lime water, aqueous ammonia solutions, aqueous solutions of organic amines.

Examples of surfactants are nonionic, anionic, cationic and/or zwitterionic surfactants. In a preferred embodiment, the cleavage is made by the use of preferably biodegradable and/or nonionic surfactants in concentrations in the range of the critical micelle concentrations or above. Preferably, the cleaving agent is a nonionic surfactant added in an amount of from 0.001 to 10% by weight, preferably from 0.01 to 1% by weight, based on the weight of the total solid phase employed in step d). The surfactant concentration is preferably at least more than its critical micelle concentration (CMC), more preferably at least twice as high as its CMC.

The breakup can also be aided mechanically, such as by ultrasound or stirring or pumping in a cycle or by milling.

It should be understood that the magnetic separation step can be carried out several times so that the purity of the separated carrier-body agglomerates is enhanced.

### Measurement Methods

### a) Particle Size Distribution

Particle size distribution measurements, including determination of D50, are performed according to ISO 13320 EN: 2009-10.

### b) Elemental Analysis

Lithium, calcium, manganese, nickel, cobalt, copper, aluminum, iron, and phosphorous (ICP-OES)

### Reagents Used:

Deionized water, hydrochloric acid (36%), K₂CO₃—Na₂CO₃ mixture (dry), Na₂B₄O₇ (dry), hydrochloric acid 50 vol.-% (1:1 mixture of deionized water and hydrochloric acid (36%)); all reagents are p.a. grade.

Sample preparation: 0.2-0.25 g of the material to be analyzed is weighed into a Pt crucible and a K₂CO₃—Na₂CO₃/Na₂B₄O₇ fusion digestion is applied: The sample is burned in an unshielded flame and subsequently completely ashed in a muffle furnace at 600° C. The remaining ash is mixed with K₂CO₃—Na₂CO₃/Na₂B₄O₇ (0.8 g/0.2 g) and melted until a clear melt is obtained. The cooled melting cake is dissolved in 30 ml of water, and 12 mL of 50 vol.-% hydrochloric acid is added. The solution is filled up to a defined volume of 100 mL. This work up is repeated three times independently; additionally, a blank sample is prepared for reference purposes.

Measurement: Li, Mg, Ca, Ni, Co, Mn, Cu, Al, Fe, P within the obtained solution is determined by optical emission spectroscopy using an inductively coupled plasma (ICP-OES). Instrument: ICP-OES Agilent 5100 SVDV; wavelengths: Li 670.783 nm; Ca 396.847 nm; Ni 231.604 nm; Co 238.892 nm; Mn 257.610 nm; Cu 324.754 nm; Al 396.152 nm; Fe 328.204 nm; P 213.617 nm; internal standard: Sc 361.383 nm; calibration: external.

### Fluorine and Fluoride (ISE)

The sample preparation for the elemental analysis of fluorine and fluoride is carried out according to DIN EN 14582:2016-12. The detection method is an ion selective electrode measurement method according to DIN 38405-D4-2:1985-07 (water samples; digestion of inorganic solids with subsequent acid-supported distillation and fluoride determination using ion selective electrode).

### Carbon

In all examples, the total carbon concentration is determined as carbon dioxide with a thermal conductivity detector after combustion as described in DIN 51732:2014-07.

### Sulfur

If not stated otherwise in the examples, sulfur is determined by catalytically combusting the sample in an argon/oxygen atmosphere whereby all sulfur is converted to a SO₂/SO₃ gas mixture. After catalytic reduction of SO₃ to SO₂. SO₂ is analyzed via IR spectroscopy.

### c) Powder X-Ray Diffraction (PXRD)

Phase compositions of solids including the identification of manganese (II) oxide, and Ni and Co in an oxidation state lower than +2 (typically metallic) are determined with powder x-ray diffraction (PXRD).

Sample preparation: The sample is ground to fine powder and filled in the sample holder.

Measurement: Two devices, each using its specific radiation source, are employed: (1) Measurement applying Cu radiation: The instrument used is a Bruker D8 Advance Series 2 with an auto-sampling unit; primary side: Cu-anode, beam spread angle aperture 0.1° with ASS; secondary side: Scattered beam aperture 8 mm with Ni 0.5 mm, Soller 4°, Lynx-Eye (3° aperture); (2) Measurement applying Mo radiation: The instrument used is a Bruker D8 Discover A25 with an auto-sampling unit; primary side: Mo-anode with Johansson monochromator (Mo—K-alpha1) with axial soller 2.5°, secondary side: ASS, Soller 2.5°, Lynx-Eye XE detector (3.77° aperture).

References are used to identify matches with the obtained reflection pattern. All relevant phases are well known in the literature; the following references are consulted and used in order to calculate the theoretical diffraction pattern (see position and intensity of re-flections in Table 1 below):
a) CoₓNi₁₋ₓ; space group Fm-3m;
   x=0.5: Taylor et al., J. Inst. Met. (1950) 77, 585-594.
   x=0: Buschow et al.; J. Magn. Magn. Mater. 1983, 38, 1-22.
b) Co; space group P6₃/mmc; Buschow et al.; J. Magn. Magn. Mater. 1983, 38, 1-22.
c) Li₂CO₃, space group C2/c; J. Alloys Compd. (2011), 509, 7915-7921
d) LiAlO₂, space group R-3m; Marezio et al., J. Chem. Phys. (1966) 44, 3143-3145.
e) MnO, space group Fm-3m, Locmelis et al., Z. Anorg. Allg. Chem. 1999, 625, 1573.

TABLE 1
Characteristic reflections (position given in °2theta and relative
intensity in %) of CoₓNi₁₋ₓ, Co, Li₂CO₃, LiAlO₂ and MnO with
intensities >10% and 2theta <80° for Cu K alpha 1 radiation):

| Compound | Hkl | 2 theta [%] | rel intensity [%] |
|---|---|---|---|
| Co_{0.5}Ni_{0.5} | 1 1 1 | 44.36 | 100 |
| | 2 0 0 | 51.68 | 46 |
| | 2 2 0 | 76.12 | 24 |
| Ni | 1 1 1 | 44.50 | 100 |
| | 2 0 0 | 51.84 | 46 |
| | 2 2 0 | 76.38 | 24 |
| Co | 1 0 0 | 41.74 | 25 |
| | 0 0 2 | 44.62 | 27 |
| | 1 0 1 | 47.60 | 100 |
| | 1 0 2 | 62.74 | 13 |
| | 1 1 0 | 76.20 | 14 |
| Li₂CO₃ | 1 1 0 | 21.24 | 100 |
| | 2 0 0 | 23.30 | 19 |
| | 2 0 −2 | 30.44 | 98 |
| | 0 0 2 | 31.76 | 96 |
| | 1 1 −2 | 34.00 | 83 |
| | 3 1 −1 | 36.72 | 81 |
| | 0 2 1 | 39.44 | 39 |
| | 2 2 −1 | 42.48 | 22 |
| | 3 1 1 | 48.58 | 52 |
| | 4 2 −1 | 57.34 | 11 |
| | 2 2 −3 | 57.90 | 19 |
| | 2 0 −4 | 59.58 | 20 |
| | 5 1 −3 | 62.86 | 12 |
| LiAlO₂ | 0 0 3 | 18.72 | 100 |
| | 1 0 1 | 37.60 | 17 |
| | 1 0 4 | 45.22 | 98 |
| | 1 0 7 | 59.30 | 17 |
| | 0 1 8 | 65.02 | 23 |
| | 1 1 0 | 66.76 | 27 |
| MnO | 1 1 1 | 34.94 | 60 |
| | 2 0 0 | 40.58 | 100 |
| | 2 2 0 | 58.72 | 58 |
| | 3 1 1 | 70.20 | 23 |
| | 2 2 2 | 73.82 | 17 |

In case of characteristic reflections overlapping with reflections of different crystalline phases (especially graphite, which contributes the largest fraction of the sample), an additional measurement employing an alternative radiation source (e.g. Mo K alpha instead of Cu K alpha) is performed.

### d) X-Ray Fluorescence (XRF)

In examples 4 and 5 metals, sulfur and phosphorous concentrations in the products were determined by XRF.

In example 4 sulfur and metals were analyzed by XRF on pressed pellets (10 g of sample and 2 g of binder Fluxana Cereox) with a PANalytical AxiosmAX (PANalytical B.V., Almelo, The Netherlands) wavelength-dispersive X-ray fluorescence spectrometer WDXRF and the PANalytical SuperQ 5 X-ray analysis software.

In example 5 the solid material was measured as powder samples in polypropylene cuvettes. The X-ray fluorescence measurements were performed using an energy dispersive Malvern PANalytical XRF spectrometer Epsilon 4 DY6024. The data were evaluated by the Omnian software of Malvern PANalytical.

### EXAMPLES

In the following three examples are described, which illustrate the three steps of the process of the present invention finally yielding aluminum hydroxide (i.e., before the refining step).

### Example 1: Preparation of Graphite/Gypsum Leach Residue

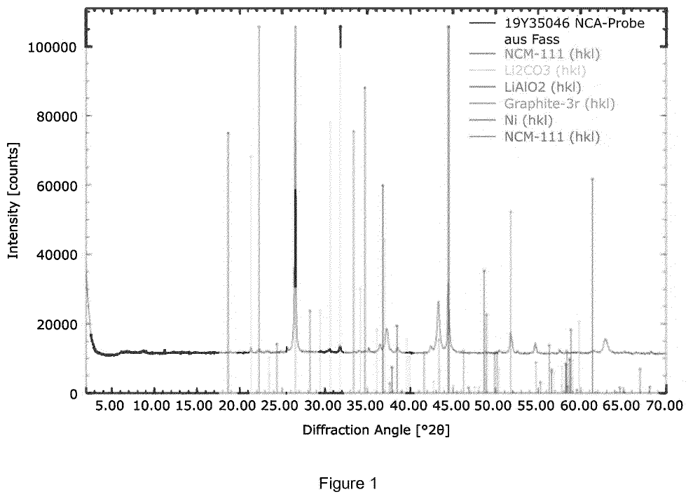

A pyrolyzed black mass obtained from the market with the composition shown in table 2 was leached with a mixture of calcium hydroxide in water. The pyrolyzed black mass was to a great extend reduced i.e., it contained only a very small peak related to lithium nickel cobalt manganese/aluminum oxide at diffraction angle 2q=18.8° and a large peak related to metallic nickel at 2q=44.4° in the PXRD spectrum (FIG. 1, black graph). For the leaching, the reactor was first flushed with nitrogen. Then, water was fed into the reactor followed by calcium hydroxide (Precal 50S from Schäfer Kalk GmbH & Co. KG). The recipe data of the calcium hydroxide leaching are summarized in table 3. To this slurry of slaked lime, the black mass was carefully added as solid. Afterwards the reaction mixture was heated to 98° C. and kept at this temperature for 6 h under stirring. Further subsequently, the heating of the vessel was stopped, and some water was evaporated by applying vacuum until the reactor content was cooled down to 70° C. The reaction mixture was then filtered by a heated suction filter (wall temperature 65-70° C.). The filter residue was cooled down to ambient temperature in the filter and washed with deionized water until the lithium concentration in the wash filtrate was 3% of the concentration in the filtrate (0.44%). The filter cake was partially dried by flushing with nitrogen for 6 h. The filter cake had an average water content of 31% its elemental composition is given in table 4.

TABLE 2
Composition of black mass used in Example 1. Concentrations
of metals and phosphorous were measured using ICP-OES,
fluorine, sulfur and carbon as described above.

| C | F | S | Al | Ca | Co | Cu | Fe | Li | Mn | Ni | P |
|---|---|---|---|---|---|---|---|---|---|---|---|
| wt % | wt % | wt % | wt % | wt % | wt % | wt % | wt % | wt % | wt % | wt % | wt % |
| 35.9 | 2.4 | 0.01 | 5.4 | 0.13 | 6.2 | 3.8 | 0.3 | 3.7 | 0.43 | 22.7 | 0.52 |

TABLE 3
Composition of reactor feed of the calcium
hydroxide leaching of Example 1.

| | Calcium | Black |
|---|---|---|
| Water | hydroxide | mass |
| wt % | wt % | wt % |
| 82.8 | 4.8 | 12.4 |

TABLE 4
Composition of the dried calcium hydroxide leaching residue (dry mass) obtained
in Example 1. Concentrations of metals and phosphorous were measured using
ICP-OES, fluorine, sulfur and carbon by combustion as described above.

| C | F | S | Al | Ca | Co | Cu | Fe | Li | Mn | Ni | P |
|---|---|---|---|---|---|---|---|---|---|---|---|
| wt % | wt % | wt % | wt % | wt % | wt % | wt % | wt % | wt % | wt % | wt % | wt % |
| 22.9 | 1.6 | 0.04 | 4.6 | 14.8 | 5.3 | 4.6 | 0.41 | 0.44 | 0.63 | 15.8 | 0.35 |

### Example 2: Leaching of the Residue of Example 1 by Sulfuric Acid

The filter cake obtained in Example 1 was leached by sulfuric acid to extract the metallic constituents. Thereby, the filter cake was mixed with water in a reactor which had been flushed with nitrogen before. To this slurry sulfuric acid (95%) was carefully added under stirring. Afterwards a solution of 30% hydrogen peroxide in water was carefully added, the composition of the reactor feed is summarized in table 6. Afterwards the reaction mixture was heated up to 90° C. and kept at this temperature for 5 h. Finally, the reaction mixture was cooled down to 50° C. and filtered. The leaching residue was washed until the Ni content in the wash filtrate reached a value below 0.2% of the Ni concentration in the filtrate. The composition of the sulfuric acid leaching residue is given in table 7.

TABLE 6
Composition of reactor feed in Example 2.

| | Leaching | Sulfuric | Hydrogen |
|---|---|---|---|
| Water | residue | acid | peroxide |
| wt % | wt % | wt % | wt % |
| 74 | 12 | 12 | 2 |

TABLE 7
Composition of the leaching residue of Example 2 (dry mass).
Concentrations of metals and phosphorous were measured using
ICP-OES, fluorine, sulfur and carbon as described above.

| C | F | S | Al | Ca | Co | Cu | Fe | Li | Mn | Ni | P |
|---|---|---|---|---|---|---|---|---|---|---|---|
| wt % | wt % | wt % | wt % | wt % | wt % | wt % | wt % | wt % | wt % | wt % | wt % |
| 27.8 | 0.1 | 11.8 | 1.6 | 15.6 | 0.06 | 0.02 | 0.02 | 0.01 | 0.02 | 0.37 | <0.01 |

The values shown in table 7 indicate that the dried leaching residue consists of 29.3% carbon and 60.2% CaSO₄ which still may contain some hydrate water. The leaching residue had an acidic pH value of approx. 2.

### Example 3: Flotation

The washed acid leach residue obtained in Example 2 was subjected to flotation experiments.

Example 3a: For this 202.7 g of the leaching residue corresponding to 129 g dry mass of the material were suspended in 1250 g tap water. The suspension was stirred at 1250 rpm in a 1.4 l lab-scale Denver flotation cell at closed air valve. Collector Shellsol D40 which is a hydrogenated C₉-C1₁ isoalkane/cycloalkane mixture with less than 2% aromatics was added as collector in an amount of 1 g corresponding to a collector concentration of 5000 g/t with respect to the dry mass of the feed material. The mixture containing the collector was stirred for 10 min then the air valve of the Denver cell was opened to allow an air flow of approx. 250 l/h. The content of the cell immediately produced a froth that was collected by regular seeping it off from the liquid surface. After 9 min flotation time additional 250 g of water were added to rise the liquid level but not much more froth could be collected. In total the flotation time was 15 min. The collected froth and the tailings were filtered and died at 80° C. in vacuo giving 34.6 and 95.0 g dry mass resp.

Example 3b: The procedure of Example 3a was repeated with slightly different feed mass of 197.5 g corresponding to 124 g dry mass and 0.6 g collector corresponding to 4800 g/t. The air flow was reduced to approx. 150 I/h to avoid very strong foaming at the beginning of the experiment. The concentrate and tailings weight after drying were 32.9 and 91.8 g resp.

The results of the flotation examples 3a and 3b are summarized in table 8.

TABLE 8
Examples 3a an 3b composition of concentrates and tailings (recoveries in brackets). Metal and
phosphorous concentrations measured by ICP-OES, fluorine, sulfur and carbon as described above.

| | Mass- | | | | | | | | | | | |
|---|---|---|---|---|---|---|---|---|---|---|---|---|
| | pull | C | F | S | Al | Ca | Co | Cu | Fe | Li | Mn | Ni |
| Fraction | % | wt % | wt % | wt % | wt % | wt % | wt % | wt % | wt % | wt % | wt % | wt % |
| Froth | 26.8 | 81.9 | 0.27 | 3.4 | 0.72 | 4.5 | 0.02 | 0.02 | 0.01 | 0.01 | <0.01 | 0.17 |
| | | (78.2) | | (7.9) | (12.1) | (7.7) | | | | | | |
| Tailings | | 8.3 | <0.1 | 14.4 | 1.9 | 19.7 | 0.02 | 0.01 | 0.03 | <0.01 | 0.01 | 0.18 |
| Froth | 26.5 | 81.2 | 0.1 | 3.2 | 0.75 | 4.2 | 0.02 | <0.01 | 0.01 | 0.01 | <0.01 | 0.17 |
| | | (77.4) | | (6.9) | (12.4) | (7.2) | | | | | | |
| Tailings | | 8.5 | <0.1 | 15.4 | 1.9 | 19.5 | 0.03 | 0.01 | 0.02 | <0.01 | 0.01 | 0.21 |

The recovery of gypsum in the tailings is derived from the sulfur and calcium recoveries in the froth subtracted from 100% i.e., 93.1% (based on sulfur).

### Example 4: Freiberg Flotation

This froth flotation process aims to separate graphite particles (C element) from gypsum particles (Ca and S elements).

Example 4a: 1286.05 g of the leaching residue obtained in Example 2 were dispersed in 9320.58 g of tap water in a 16 l Outotec lab flotation cell GTK. 1 g of kerosene and 400 μl methyl isobutyl carbinol (MIBC) were added as collector and frother resp. and the cell content was flotated at a rotor speed of 1000 rpm. The air flow rate was 300 l/h and the scraping frequency was 0.0625 l/sec. In total 382.55 g (dry mass) of concentrates were collected within 8.6 min. After this rougher stage the tailings (903.5 g dry mass) were left in the flotation cell and conditioned again with 0.3 g kerosene and 150 μl MIBC. Then the scavenger flotation started with a rotor speed of 1000 rpm and 300 l/h air flow rate. From this scavenger flotation stage another 38 g concentrate (dry mass) and 865 g tailings (dry mass) were recovered within 6 min.

Example 4b: 2031.04 g of the leaching residue obtained in Example 2 were dispersed in 9534.72 g of tap water in a 16 l Outotec lab flotation cell GTK. 1 g of kerosene and 400 μl methyl isobutyl carbinol (MIBC) were added as collector and frother resp. and the cell content was flotated at a rotor speed of 1000 rpm. The air flow rate was 300 l/h and the scraping frequency was 0.0625 l/sec. Similar to example 3a a rougher and a scavenger stage were combined. In total 459.13 g (dry mass) of combined rougher and scavenger concentrate and 1571.91 g of tailings were collected. After this the combined concentrates were resuspended in the flotation cell, 0.3 g kerosene and 150 μl MIBC were added and then the flotation started with a rotor speed of 1000 rpm and 300 l/h air flow rate. From this cleaner flotation stage another 383.62 g concentrate (dry mass) and 75.51 g tailings (dry mass) were recovered within 31 min.

The results of Examples 4a and 4b are summarized in table 9.

TABLE 9
Examples 4a and 4b composition of concentrates and tailings (recoveries in brackets); metal,
sulfur and phosphorous concentrations measured by XRF, carbon as described above.

| | | | | | | | | | | |
|---|---|---|---|---|---|---|---|---|---|---|
| | Mass- | | | | | | | | | |
| | pull* | C | Al | Co | Cu | Fe | Mn | Ni | Ca | S |
| Fraction | % | wt % | wt % | wt % | wt % | wt % | wt % | wt % | wt % | wt % |

Example 4a

| | | | | | | | | | | | |
|---|---|---|---|---|---|---|---|---|---|---|---|
| Rougher | Froth | 29.75 | 82.21 | 0.5 | 0.01 | 0.02 | 0.01 | 0.01 | 0.12 | 4.36 | 3.37 |
| | | | (88.5) | (17.5) | | | | | | | |
| Scavenger | Froth | 2.99 | 90.5 | 0.56 | 0.01 | 0.01 | 0.02 | 0.01 | 0.12 | 1.50 | 1.19 |
| | | | (9.8) | (1.97) | | | | | | | |
| | Tailings | | 0.7 | 1.02 | 0.01 | 0.02 | 0.01 | 0.01 | 0.11 | 16.13 | 12.90 |
| | | | | | | | | | | (89.0) | (89.32) |
| Total | Froth | 32.74 | 82.97 | 0.51 | 0.01 | 0.01 | 0.01 | 0.01 | 0.12 | 4.10 | 3.17 |
| | | | (98.3) | (19.5) | | | | | | (11.0) | (10.68) |

Example 4b

| | | | | | | | | | | | |
|---|---|---|---|---|---|---|---|---|---|---|---|
| Rougher + | Froth | 22.16 | 85.18 | 0.55 | 0.01 | 0.01 | 0.02 | 0 | 0.12 | 2.3 | 1.89 |
| Scavenger | | | (99.2) | (10.8) | | | | | | (2.91) | (2.95) |
| | Tailings | | 0.2 | 1.34 | 0.02 | 0.00 | 0.02 | 0.02 | 0.15 | 22.37 | 18.15 |
| | | | (0.8) | (89.2) | | | | | | | |
| Cleaner | Froth | 18.89 | 97.2 | 0.32 | 0.01 | 0.01 | 0.01 | 0.00 | 0.11 | 0.05 | 0.06 |
| | | | (94.6) | (5.2) | | | | | | | |
| | Tailings | | 24.1 | 1.73 | 0.02 | 0.05 | 0.02 | 0.01 | 0.16 | 13.70 | 11.20 |
| | | | | | | | | | | (99.94) | (99.93) |
| Total | Froth | 18.89 | 97.2 | 0.32 | 0.01 | 0.01 | 0.01 | 0.00 | 0.11 | 0.05 | 0.06 |
| | | | (94.6) | (5.2) | | | | | | (0.06) | (0.07) |

*all mass-pull data are related to the feed mass

The recovery of gypsum in the tailings is derived from the sulfur and calcium recoveries in the froth subtracted from 100% i.e., 89.3% for Example 4a and 99.9% for Example 4b (based on sulfur each).

### Example 5

A washed acid leach residue obtained in Example 2 but with a composition as shown in table 10 was subjected to a separation experiment employing magnetic separation using magnetic carrier bodies. For this 20 g (dry mass) of the leach residue were suspended in 60 g tap water. The suspension was de-agglomerated by treatment with an UltraTurrax UT25 for 5 min at 10000 rpm. During this treatment the pH-value was adjusted to 3 by addition of NaOH solution. To the suspension 0.5 g Shellsol D40 were added and homogenized by additional 5 min stirring at 10000 rpm with the UltraTurrax UT25. To this suspension a suspension of 0.6 g of hydrophobized magnetite (prepared according to Example 1 of WO 2015/110555 based on magnetite particles with a D50 4 μm and a polyorganosiloxane (a solid methyl silicone resin, Mp 35-55° C., average composition of approximately [CH₃SiO_{1.5}]₁₀₀ having a molecular weight Mw of approximately 6700 g/mol) suspended in 3.6 g of an aqueous solution of 0.1% Lutensol XL80 in water was added and stirred for 15 min with a pitch blade stirrer at 1400 rpm. This suspension was then pumped at a rate of 6 l/h to a lab-scale magnetic separator Eriez LH4 equipped with a 4×1 mm wedged wire matrix at a magnetic field strength of 0.7 T. After this the matrix was rinsed with water to completely recover the non-magnetic fraction. Then the magnetic field was switched off and the magnetic fraction was flushed from the matrix with water. By this 5.43 g magnetic fraction (concentrate) and 13.36 g non-magnetic (tailings) (all dry masses) were recovered. The results of Example 5 are summarized in table 11.

TABLE 10
Composition of the sulfuric acid leach residue employed in example
4 (dry mass). Metal and phosphorous concentrations measured by
ICP-OES, fluorine, sulfur and carbon as described above.

| C | F | S | Al | Ca | Co | Cu | Fe | Mn | Ni | P |
|---|---|---|---|---|---|---|---|---|---|---|
| wt % | wt % | wt % | wt % | wt % | wt % | wt % | wt % | wt % | wt % | wt % |
| 23.2 | 0.1 | 12.7 | 6.4 | 9.8 | 0.06 | 0.25 | 0.06 | 1 | 0.64 | 0.51 |

TABLE 11
Examples 5 composition of concentrates (magnetite has been subtracted by
calculation) and tailings (recoveries in brackets); metal, sulfur and
phosphorous concentrations measured by XRF, carbon as described above.

| | Mass-pull | C | Al | Ca | Co | Cu | Mn | Ni | S | P |
|---|---|---|---|---|---|---|---|---|---|---|
| Fraction | % | wt % | wt % | wt % | wt % | wt % | wt % | wt % | wt % | wt % |
| Froth | 24.2 | 87.5 | 3.9 | 0.2 | 0.08 | 0.08 | 0.06 | 0.19 | 0.2 | 0.3 |
| | | (91.3) | (14.7) | (49.4) | | | | | (38.1) | |
| Tailings | | 2.0 | 10.6 | 16.1 | 0.09 | 0.08 | 0.08 | 0.09 | 12.8 | 0.7 |

The recovery of gypsum in the tailings is derived from the sulfur and calcium recoveries in the froth subtracted from 100% i.e., 61.9% (based on sulfur).

1. A process for recycling carbon and a hardly soluble alkaline earth sulfate from a leaching residue, comprising the steps of:
contacting in an alkaline earth metal contacting step a lithium battery material with an alkaline earth metal comprising material in a solvent yielding an alkaline earth metal contacted lithium battery material;
leaching in a leaching step the alkaline earth metal contacted lithium battery material in sulfuric acid yielding a leaching solution and the leaching residue, wherein the leaching residue comprises carbon and the hardly soluble alkaline earth sulfate;
separating in a solid-liquid separation step the leaching residue from the leaching solution;
suspending in a suspension step the leaching residue in a solvent yielding a suspended leaching residue;
contacting in a carrier contacting step the suspended leaching residue with a plurality of at least one type of a carrier body,
wherein
at least a part of the carbon comprised in the suspended leaching residue is agglomerated with the plurality of at least one type of a carrier body,
yielding a suspension comprising
carrier-body agglomerates comprising carbon, and
non-agglomerates comprising the hardly soluble alkaline earth sulfate,
or wherein
at least a part of the hardly soluble alkaline earth sulfate comprised in the suspended leaching residue is agglomerated with the plurality of at least one type of a carrier body,
yielding a suspension comprising
carrier-body agglomerates comprising the hardly soluble alkaline earth sulfate, and
non-agglomerates comprising carbon; and
separating in a solid-solid separation step at least a part of the carrier-body agglomerates from the suspension.

2. The process according to claim 1, wherein the alkaline earth metal is calcium, and the hardly soluble alkaline earth sulfate is calcium sulfate.

3. The process according to claim 1, wherein the lithium battery material is a pyrolyzed lithium battery material.

4. The process according to claim 1, wherein the carbon is amorphous carbon or crystalline carbon.

5. The process according to claim 1, wherein the solid-liquid separation step is carried out as a separation step selected from the group consisting of a filtration step, a centrifugation step, a sedimentation step, and a decantation step.

6. The process according to claim 1, wherein the solid-solid separation step is a flotation and the carrier bodies are bubbles from a carrier gas.

7. The process according to claim 6, wherein the carrier gas is a gas being inert to the suspension.

8. The process according to claim 6, wherein the flotation is done in a mechanical flotation cell, in a pneumatic flotation cell, or in a column flotation cell, or in a combination of at least two of these cells.

9. The process according to claim 1, wherein the solid-solid separation step is a magnetic separation, and the carrier bodies are magnetic particles.

10. The process according to claim 9, wherein the separated carrier-body agglomerates are split allowing the separation of the magnetic carrier-bodies from the non-magnetic carbon or hardly soluble alkaline earth sulfate particles by a magnetic separation step.

11. The process according to claim 9, wherein the magnetic particles comprise hydrophobized magnetite.

12. The process according to claim 1, wherein in the carrier contacting step prior to the addition of the carrier body the pH value of the solvent is adjusted to a pH value of higher than 3.

13. The process according to claim 12, wherein the pH value is adjusted by addition of a base selected from the group consisting of alkali hydroxides, alkali carbonates, ammonium hydroxide, alkali earth hydroxides, alkali earth carbonates and mixtures thereof.

14. The process according to claim 1, wherein the carrier contacting step comprises addition of a collector and optionally a frother.

15. The process according to claim 14, wherein the collector is selected from the group consisting of non-polar hydrocarbons.

16. The process according to claim 14, wherein the frother is a surfactant.

17. Graphite obtained by the process according to claim 1.

18. Barium sulfate obtained by the process according to claim 1.

19. Calcium sulfate obtained by the process according to claim 1.

20. The process according to claim 1, wherein the lithium battery material is a pyrolyzed black mass originating from a lithium battery.
